(19) United States
(12) Patent Application Publication
(10) Pub. No.: US 2018/0126427 A1
(43) Pub. Date: May 10, 2018

(54) FLUID DISPENSING LINE CLEANING METHOD AND APPARATUS

(71) Applicants: DEVIN HASELWOOD, FERNDALE, MI (US); JUSTIN IVEY, BEVERLY HILLS, MI (US)

(72) Inventors: DEVIN HASELWOOD, FERNDALE, MI (US); JUSTIN IVEY, BEVERLY HILLS, MI (US)

(21) Appl. No.: 15/143,490

(22) Filed: Apr. 29, 2016

(51) Int. Cl. B08B 9/032; B67D 1/07

(52) U.S. Cl. CPC B08B 9/0325; B67D 2001/075; B67D 1/07

(57) ABSTRACT

An apparatus is presented whereby fluid dispensing means may be efficiently cleaned and/or sanitized. A controlling device directs actuators to seal and release valves by which gas and liquid may be introduced into removed from a channel. Preferably, a first valve is closed such that a selected fluid may no longer flow into the channel, and pressurized gas is introduced into the channel, for the purpose of cleaning the channel. A cleaning agent may additionally be used to augment the steam in the cleaning process. Additionally or optionally flushing agent, such as water, may be introduced into the channel after the pressurized gas in order to flush out any residue left from the cleaning process.

### FIELD OF THE INVENTION

The present invention relates to systems and methods of fluid dispensing and hygiene. More particularly, the present invention relates to the means by which fluid dispensing systems may be cleaned and/or sanitized.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The liquid refreshment industry, including taverns and the beer and spirits industry in general, are growing global businesses. In just the one industrial sector of beer and ale delivery, there is growing involvement and participation of numerous regional and multinational companies and many thousands of smaller producers including brewpubs, regional breweries, and in-home production facilities. The means by which fluid dispensing means are cleaned, however, can too often be unreliable, hygienically suboptimal, economically inefficient. Current methods of fluid dispensing generally require manual cleaning which involves labor-intensive processes that may an undesirable amounts of time. Furthermore, the prior art methods typically require human judgment, integrity and extensive training processes, thereby limiting the number of individuals who be relied upon to perform proper dispensing systems cleaning without supervision.

There is therefore a long-felt need to provide increased efficiencies in the means by which fluid dispensing means are flushed out, cleaned and/or sanitized.

### SUMMARY AND OBJECTS OF THE INVENTION

Towards these objects and other objects that will be made obvious in light of the present disclosure, a cleaning method and means for fluid dispensing apparatuses is presented. In a first preferred embodiment of the present invention, a controlling device is bidirectionally coupled with a plurality of modules, wherein the plurality of modules are preferably electromechanical. A liquid material transference channel is additionally presented about which the plurality of modules are preferably placed. A first module preferably comprises a first switch, and the first switch is preferably directed by the controller to actuate upon direction from the controller in order to seal and/or release a liquid entry aperture. A second switch is additionally coupled with the controlling device, wherein the second switch actuates upon direction from the controlling device such that the second switch may inhibit or allow a flow of a cleaning agent through a cleaner entry aperture. The cleaning agent may optionally comprise pressurized gas, and when the cleaning agent comprises a pressurized gas, a reservoir containing the pressurized gas is preferably coupled with the channel, and a reservoir switch coupled with the controlling device, wherein the controlling device preferably unseals the reservoir only when the second switch is open. The controlling device preferably directs the switches to actuate in such a way that, when liquid may flow through the liquid entry aperture, the cleaner entry aperture is sealed, and when a cleaning agent is flowing through the cleaner entry aperture, the liquid entry aperture is sealed, to inhibit the intermingling of the liquid and the cleaning agent. A third module preferably comprises a flushing switch, wherein the flushing switch may be directed by the controlling device to seal and/or release a flushing entry aperture such that a flushing agent, such as water, may enter the channel. The controlling device is enabled to inhibit the entry of the liquid, the cleaning agent, and the flushing agent into the channel simultaneously. A fourth module comprising a channel exit switch is additionally presented, wherein the channel exit switch may be directed by the controlling device to seal and/or release the flow of the liquid or the cleaning agent, or the flushing agent out of a channel exit feature.

In an alternate preferred embodiment of the present invention, an apparatus is presented wherein a controller is enabled to actuate and control a plurality of electromechanical means, comprising a first means which enables and disables a movement of liquid through a channel and out of an exit port; and a second means, wherein the second means enables and disables the flow of a cleaning agent liquid into the channel and through the exit port. The controlling device preferably inhibits the flow of the liquid through the first means when the cleaning agent liquid flows through the second means, and preferably inhibits the flow of the cleaning agent liquid through the second means when the liquid flows through the first means.

Additionally presented is a method of the present invention (hereinafter “invented method”), wherein a liquid, optionally and preferably comprising alcohol, particularly beer, is flowed through a channel. The flow of the liquid is subsequently preferably temporarily halted by the controller in an automated process, preprogrammed into the controller. Upon halting the flow of the liquid through the channel, a cleaning agent is preferably passed through the channel, wherein the cleaning agent preferably comprises steam or an alternate compressed gas. The controller halts the introduction of the cleansing agent to the channel after a predetermined period of time, and the flow of the liquid through the channel is resumed.

It is understood that the scope of meaning of the term “beer” as defined and used within this disclosure includes alcoholic beverages made from yeast-fermented malt flavored with hops, including beer as defined by the Laws of the United States, porter, stout, ale, iambic and lager. It is further understood that the scope of the present invention extends to method and system embodiments adapted to dispense beverages containing alcohol, e.g., wines, spirits and other intoxicant containing fluids known in the art, non-alcoholic beverages, e.g., water, mineral water and soft drinks known in the art. The scope of the present invention additionally extends to embodiments enabled to dispense non-potable fluids, such as in the manufacture and use of biofuel fluids, and other non-potable fluids known in the art.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1A is a system component overview of the invented apparatus;

FIG. 1B is a block diagram of the controller;

FIG. 1C is a block diagram of a computer;

FIG. 2 is a flowchart of a preferred embodiment of the invented method;

FIG. 3 is a logical overview of the invented device;

FIG. 4 is a diagram of a first embodiment of the invented device; and

FIG. 5 is a diagram of an additional embodiment of the invented device.

### DETAILED DESCRIPTION

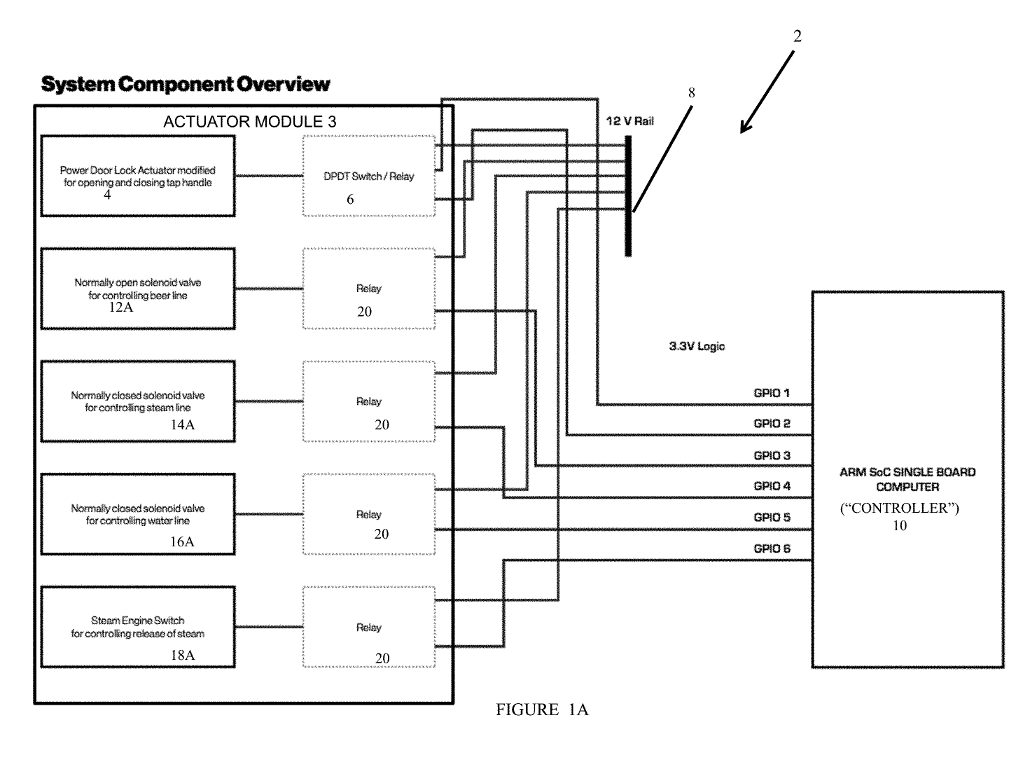

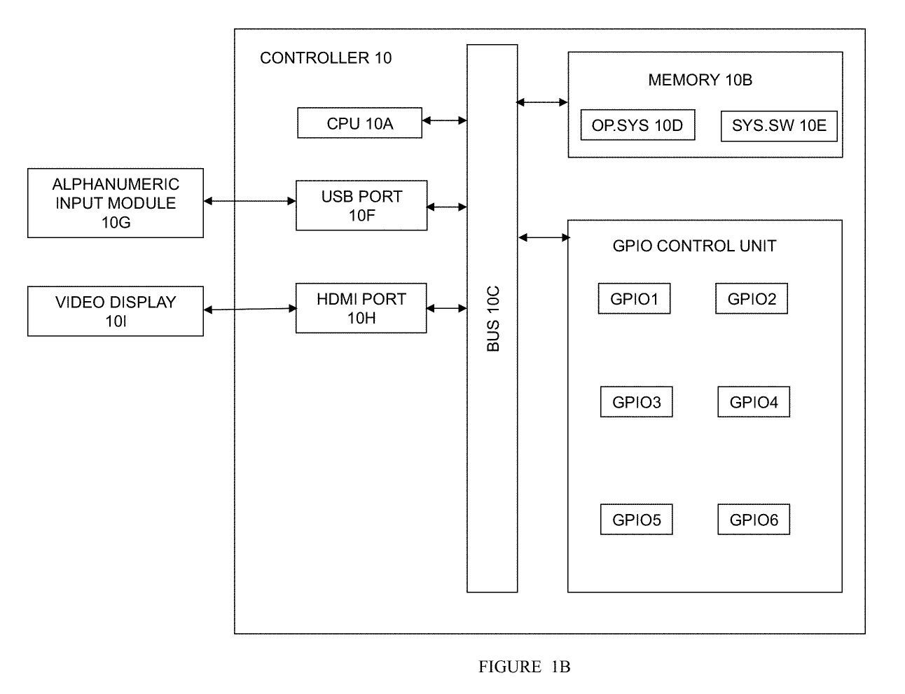

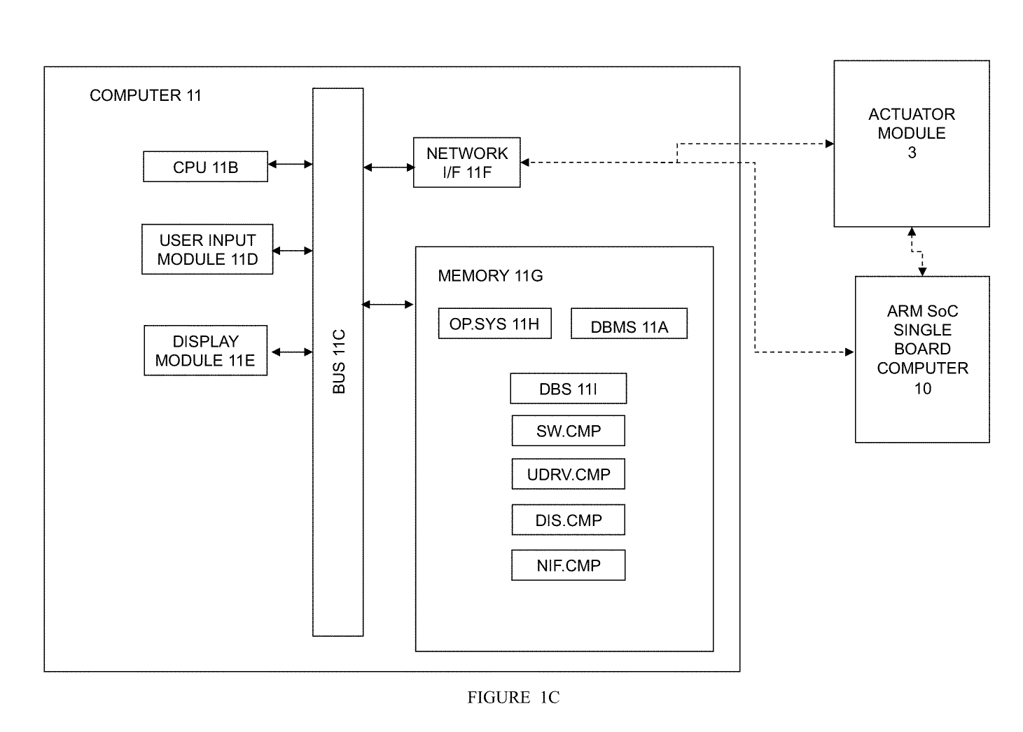

Referring now generally to the Figures, and particularly to FIG. 1A, FIG. 1A is a system component overview of the invented apparatus 2 (hereinafter “apparatus 2”). The apparatus 2 first preferably comprises an actuator module 3. The actuator module 3 preferably comprises a channel exit switch 4 (hereinafter “tap actuator 4”) which is bidirectionally coupled to a DPDT switch/relay 6, which is additionally coupled to a twelve-volt rail 8, and to the controller 10, presented herein as an exemplary ARM SoC single board computer™ 9, by means of a first general purpose input/output signal line (hereinafter “GPIO1”) and a second general purpose input/output signal line (hereinafter “GPIO2”). The controller 10 may alternately optionally be or comprise, but is not limited to, a Quark™ SoC, microcontroller as marketed by Intel Corporation of Santa Clara, Calif.; an Arduino-compatible ATmega128 ™ microcontroller, as marketed by Atmel Corporation of San Jose, Calif.; and/or the MIPS Creator as marketed by Imagination Technology, PLC of Kings Langley, Hertfordshire, United Kingdom. Additionally presented are a beer valve actuator 12A which is preferably open when the apparatus 2 is in a neutral mode, a steam valve actuator 14A which is preferably closed when the apparatus 2 is in a neutral mode, a water valve actuator 16A which is preferably closed when the apparatus 2 is in a neutral mode, and a steam engine actuator 18A which controls the release of steam into the apparatus 2, and is preferably closed when the apparatus 2 is in a neutral mode. Each actuator 12A-18A is preferably coupled with a relay 20, by which the actuator 12A-18A is bidirectionally coupled with the twelve-volt rail 8, and the controller 10. The beer valve actuator 12A is connected to the controller 10, via the relay 20, by means of a third general purpose input/output signal line (hereinafter “GPIO3”); the steam valve actuator 14A is preferably connected to the controller 10, via the relay 20, by means of a fourth general purpose input/output signal line (hereinafter “GPIO4”); the water valve actuator 16A is preferably connected to the controller 10, via the relay 20, by means of a fifth general purpose input/output signal line (hereinafter “GPIO5”); and the steam engine actuator 18A is preferably connected to the controller 10, via the relay 20, by means of a sixth general purpose input/output signal line (hereinafter “GPIO6”).

Referring now generally to the Figures, and particularly to FIG. 1B, FIG. 1B, is a block diagram of the controller 10, wherein the controller 10 comprises: a central processing unit (“CPU”) 10B; a user input module 10D; a display module 10E; a software bus 10C bi-directionally communicatively coupled with the CPU 10B, the user input module 10D, the display module 10E; the software bus 10C is further bi-directionally coupled with a network interface 10F; and a memory 10G. The software bus 10C facilitates communications between the above-mentioned components of the controller 10. The network interface 10F preferably allows the controller 10 to optionally interact with and/or replace the ARM SoC single board computer 9, and to interact with the actuator module 3.

The memory 10G of the controller 10 includes a software operating system OP.SYS 10H. The software OP.SYS 10H of the controller 10 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, or WINDOWS 8 ™ operating system as marketed by Microsoft Corporation of Redmond, Wash.; or the MAC OS X operating system or iPhone G4 OS™ as marketed by Apple, Inc. of Cupertino, Calif. The memory 10G further includes a software SW.CNT, a user input driver UDRV.CNT, a display driver DIS.CNT, and a network interface drive NIF.CNT.

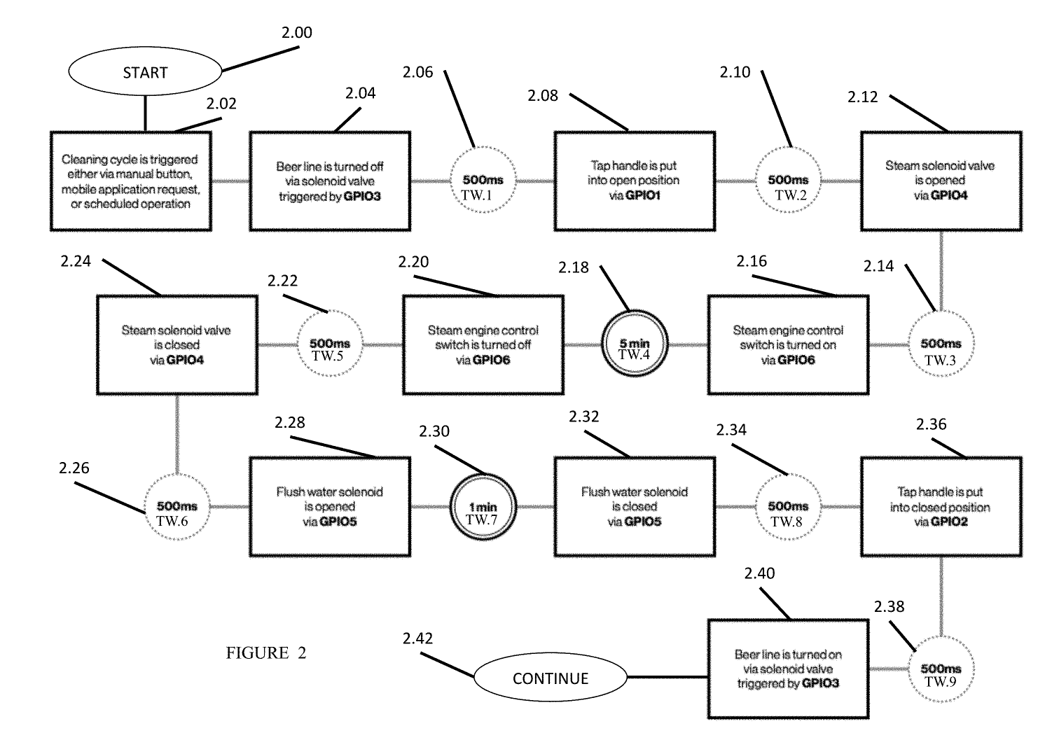

Referring now generally to the Figures, and particularly to FIG. 1C, FIG. 1C is a block diagram of a computer 11. The computer 11 comprises a computer central processing unit (“CPU”) 11B; a computer user input module 11D; a computer display module 11E; each bidirectionally communicatively coupled with a computer communications bus 11C, which is additionally bidirectionally coupled with a computer network interface 11F and a computer memory 11G. The computer network interface is additionally coupled with the actuator module 3, and with the controller 10. Contained within the memory 11G of the computer 11 are a computer operating system OP.SYS 11H and a computer database management system (“DBMS”) 11A, as well as a computer database DBS11I; a computer system software SW.CMP, which enables the computer 11 to enact and instantiate the method of the present invention; a computer user input driver UDRV.CMP; a display driver DIS.CMP; and a network interface driver NIF.CMP. More particularly the computer system software SW.CMP enables the method of the present invention as disclosed in the FIG. 2 to be embodied by application of the one or more of the components of the method of the present invention as disclosed in FIGS. 1A, 1B and 3 through 5 and as described in the accompanying text.

The software OP.SYS 11H of the computer 11 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, or WINDOWS 8 ™ operating system as marketed by Microsoft Corporation of Redmond, Wash.; or the MAC OS X operating system or iPhone G4 OS™ as marketed by Apple, Inc. of Cupertino, Calif.

Referring now generally to the Figures, and particularly to FIG. 2, FIG. 2, is a flowchart of a preferred embodiment of the invented method. In step 2.02 a cleaning cycle is triggered. The triggering means for the cleaning cycle may optionally be via a manual button positioned on or near the apparatus 2, via a mobile application, remote from the location of the apparatus 2, or may optionally be according to a previously determined cleaning schedule. In step 2.04 the controller 10 directs the beer valve actuator 12A to seal the beer valve 12B by means of the GPIO3, cutting off a beer line 22 into a channel 24. The beer line 22 is preferably composed of high pressure reinforced silicone tubing, and the steam line 28 preferably comprises or is composed of stainless steel tubing or other suitable material known in the art. All other fluid or gas channeling components of the apparatus 2 are preferably composed of cast stainless steel and/or other suitable materials known in the art. In step 2.06 a first waiting period TW.1 of 500 milliseconds is allowed to elapse, and in step 2.08 the controller 10 directs a channel exit feature 25 (hereinafter “tap 25”) to be placed into an “open” position via the GPIO1, such that any remaining beer in the channel 24 is allowed to drain from the channel 24. A second waiting period TW.2 of 500 milliseconds elapses in step 2.10, and in step 2.12 the controller 10 directs the steam valve actuator 14A to open the steam valve 14B. In step 2.14, a third waiting period TW.3 of 500 milliseconds is enacted, and the steam engine actuator 18A is directed to engage the steam engine 18B by the controller 10 via the GPIO6 in step 2.16. In step 2.18, a fourth waiting period TW.5 of five minutes is enacted by the controller 10 to allow for thorough cleaning and/or sanitizing of the channel 24 by the steam, in the current embodiment, or by an alternate suitable compressed gas known in the art. In step 2.20 the controller 10 directs the steam engine actuator 18A to turn off via the GPIO6. In step 2.22 a fifth waiting period TW.5 of 500 milliseconds is enacted by the controller 10, and in step 2.24 the controller 10 directs the steam valve actuator 14A to close steam valve 14B via the GPIO4. In step 2.26 a sixth waiting period TW.6 of 500 milliseconds is enacted by the controller 10, and in step 2.28 the controller 10 directs the water valve actuator 16A to open the water valve 16B via the GPIO5. A flushing liquid is, in the present embodiment, water, but may optionally be any liquid known in the art capable of flushing out a channel. In step 2.30 the controller water valve 16B remains open for a seventh waiting period SW.7 of one minute in order to ensure a thorough flushing of the channel 24, and in step 2.32 the controller 10 directs the water valve actuator 16A to close the water valve 18B via the GPIO5. In step 2.34, an eighth waiting period TW.8 of 500 milliseconds is enacted by the controller 10, and in step 2.36 the tap 25 is placed into a “closed” position, in order to impede any additional flow of liquid or compressed gas through the tap. In step 2.38 a ninth waiting period TW.9 of 500 milliseconds is enacted by the controller 10, and the controller 10 directs the beer line 22 to re-engage via the GPIO3 in step 2.40. In step 2.42 the controller 10 continues to alternate operations. It is understood that the time periods described by the waiting periods TW.1-TW.9 are given by example only, and are not intended to limit the scope of the invention to any specific amount of time. It will also be clear to one well versed in the art that the relatively short time which elapses during the entire cleaning process as described above is a significant improvement on current methods of cleaning and sanitizing beer containing and dispensing means, which may frequently be extremely time-intensive.

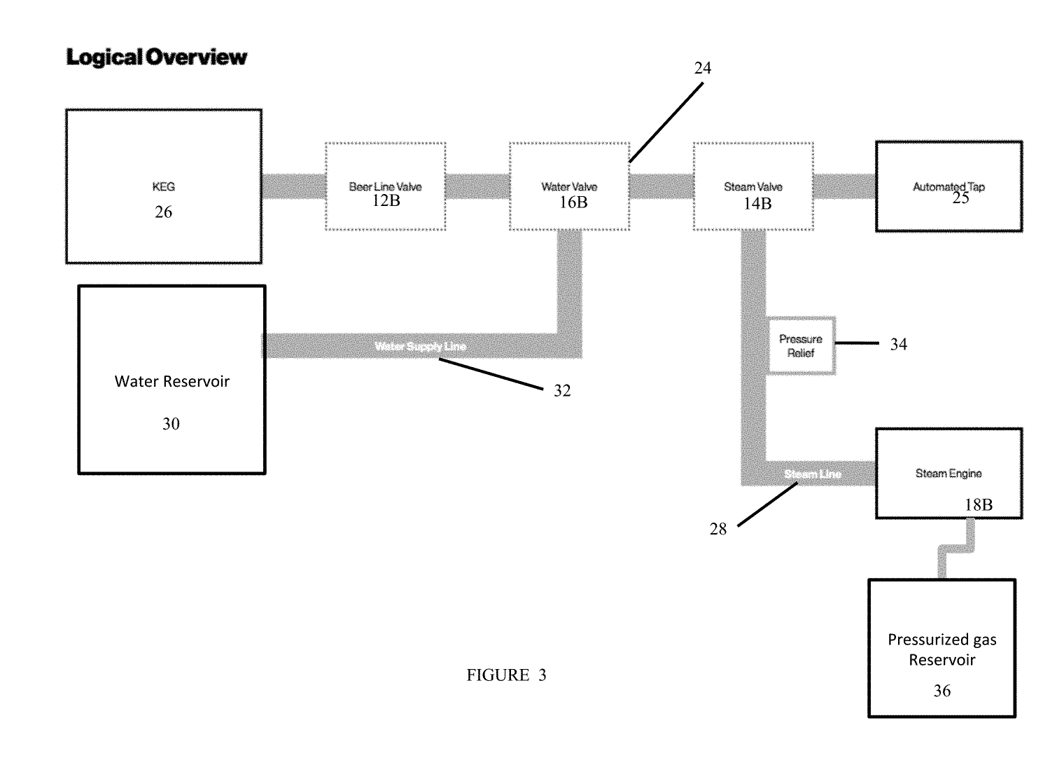

Referring now generally to the Figures, and particularly to FIG. 3, FIG. 3 is a logical overview of the apparatus 2. A keg 26 is shown to be connected to the tap 25 via the beer valve 12B, the water valve 16B, and the steam valve 14B. The water valve 16B is additionally shown to be connected to a water reservoir 30 via a water supply line 32. The flow of water through the water supply line and through the water valve 16B is controlled by the controller 10 through the GPIO5 and the water valve actuator 16A. The steam valve 14B is additionally connected to the steam engine 18B by means a steam line 28. Along the steam line 28 is a pressure relief valve 34 by which steam or other pressurized gas may be released from the steam line 28 without introducing the pressurized gas into the channel 24. The steam engine 18B is further coupled with a pressurized gas reservoir 36 from which the steam engine 18B may gather and/or generate steam or other pressurized gas.

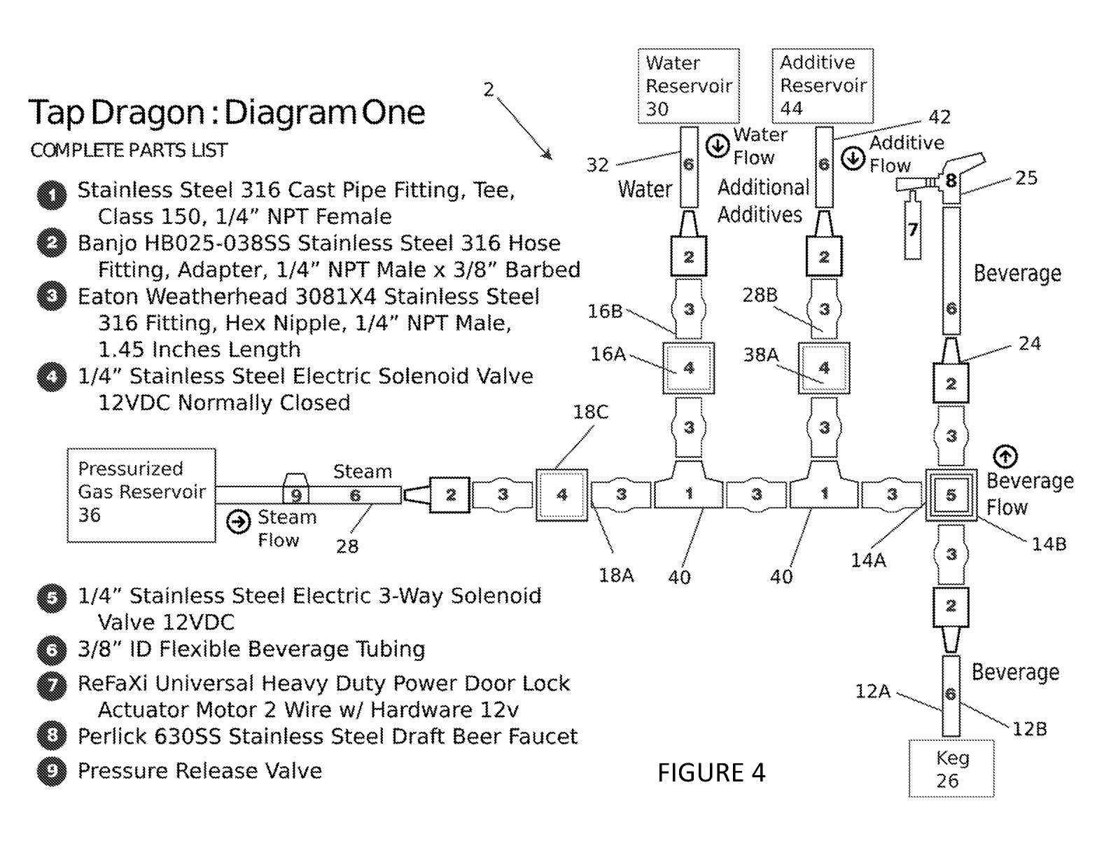

Referring now generally to the Figures, and particularly to FIG. 4, FIG. 4 is a diagram of a first embodiment of the apparatus 2. Shown is the pressurized gas reservoir 36, leading to the steam line 28, which is composed of a plurality of electromechanical modules 40 (hereinafter “modules 40). The steam line 28 is shown to lead to the steam engine valve 18C, the opening and closing of which is controlled by the steam engine valve actuator 18A, which receives instructions from the controller 10. Additional modules 40 couple the steam engine valve 18C and the steam engine valve actuator 18A to the water valve 16B and the water valve actuator 16A, the water valve actuator 16A controlling the ingress and egress of water through the water valve 16B by means of instructions from the controller 10. The water supply line 32 leads from the water valve 16B to the water reservoir 30 (not shown); the water supply line 32 is shown to lay at an orthogonal angle to the steam line 28. Also shown to be at an orthogonal angle to the steam line 28, coupled thereto by means a plurality of modules 40, is a cleaning agent line 42 (hereinafter “additive line 42”) extending from a cleaning agent reservoir 44 (hereinafter “additive reservoir 44”) by which additional cleaning agents and additives, including, but not limited to, citric acid, phosphoric acid, Sodium Hydroxide, caustic solutions and agent, acidic solutions and agents, base solutions and agents, and other suitable cleaning agents and additives known in the art, may be introduced into the cleaning process. Coupled to the additive line 42 by means of modules 40 are shown an additive valve 38B through which additives may be introduced into the cleaning process, and an additive valve actuator 38A which controls the seal of the additive valve 38B by means of instructions from the controller 10. Shown at the terminus of the steam line 28, at an orthogonal angle thereto, is the channel 24 through which beer may flow from the keg 26 to the automated tap 25. The steam valve 14B and the steam valve actuator 14A are shown to be located at the terminus of the steam line 28, such that, when beer is flowing, the steam and/or water and/or additives may be inhibited from flowing into the channel 24 by means of the steam valve actuator 14A receiving instructions from the controller 10. Alternatively, when a cleaning cycle is triggered, the flow of beer from the keg 26 is ceased by means of the beer valve actuator 12A receiving instructions from the controller 10, and shutting the beer valve 12B, and the steam and/or water and/or additives may flow freely into the channel 24. When the cleaning process is complete, the steam and/or water and/or additives are released through the tap 25, and the steam valve 14B is closed, and the beer valve 12B is opened, such that beer may flow freely to the tap 25.

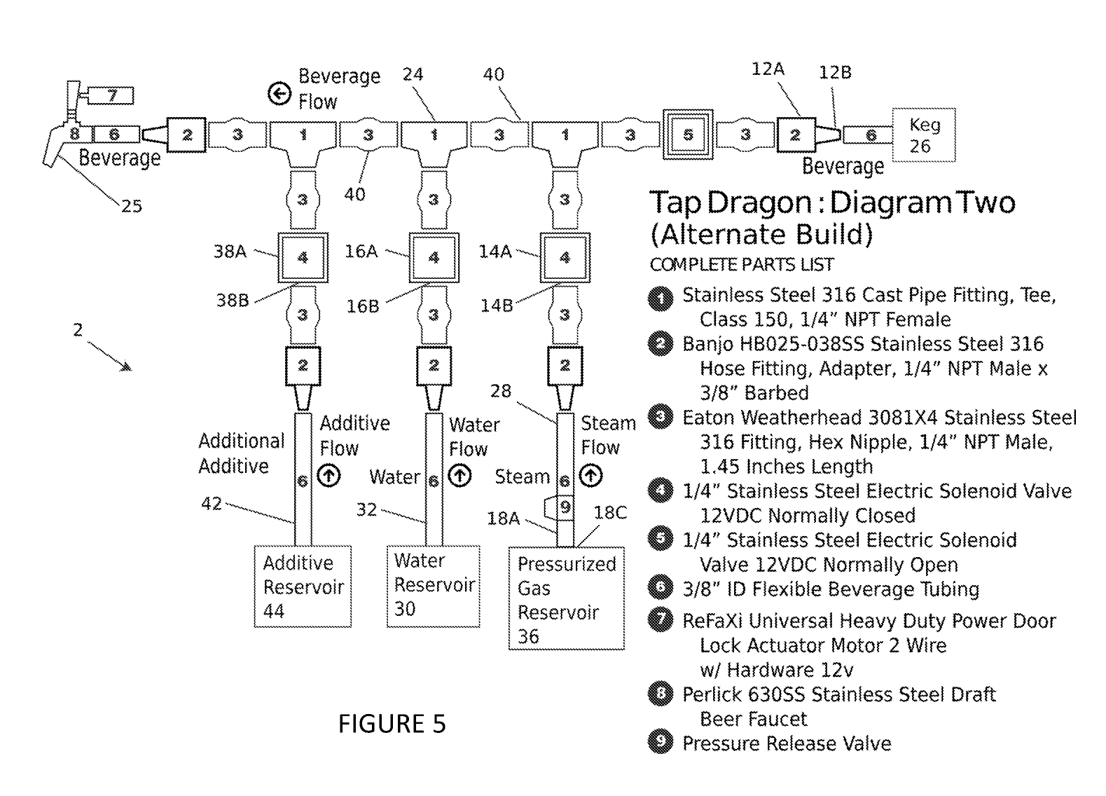

Referring now generally to the Figures, and particularly to FIG. 5, FIG. 5 is an alternate preferred arrangement of the valves 12B-18B and the conduits through which pressurized gas and/or fluids may flow in order efficiently clean and/or sanitize the channel 24. The keg 26 and the tap 25 are shown to lay at either lateral end of the channel 24. The steam line 28, the water supply line 32, and the additive supply line 42 each lay perpendicular to one another, and orthogonally to the channel 24. When the additive valve 38B is directed to be open by the controller 10, the additive flows along the additive supply line 42 from the additive reservoir 44 toward the channel 24; when the water valve 16B is directed to be open by the controller 10, water flows along the water supply line 32 from the water reservoir 30 toward the channel 24; and when the steam valve 14B is directed to be open by the controller 10, steam flows along steam line 28 toward the channel 24 from the pressurized gas reservoir 36 in order to clean and sanitize the channel 24. Alternately, when the additive valve 38B, the water valve 16B, and the steam valve 14B are closed, and the beer valve 12B is open, the beer flows along the channel 24 from the keg 26 toward the tap 25.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. An apparatus comprising:
a controller, the controller adapted to selectively enable and disable a plurality of electromechanical modules (“plurality of modules”);
a channel, the channel adapted to provide a transference pathway of a liquid material;
a first switch of the plurality of modules, the first switch coupled with the controller and adapted as directed by the controller to alternately expose and seal a liquid entry aperture, the liquid entry aperture adapted to enable liquid material to enter the channel;
a second switch of the plurality of modules, the second switch coupled with the controller and adapted as directed by the controller to alternately expose and seal a cleaner entry aperture, the cleaner entry aperture adapted to enable a cleaning agent to enter the channel, and wherein the controller is adapted to control the first switch and the second switch to prohibit a simultaneous entry of the cleaning agent and the liquid medium into the channel; and
a channel exit feature, the channel exit feature coupled with the channel and adapted to enable exit of both the liquid material and the cleaning agent from the channel.

2. The apparatus of claim 1, further comprising a channel exit switch, the channel exit switch coupled with the controller and adapted as directed by the controller to alternately enable and disable the channel exit feature from permitting exit of the cleaning agent and the liquid material from the channel.

3. The apparatus of claim 1, wherein the liquid material comprises alcohol.

4. The apparatus of claim 1, wherein the liquid material comprises beer.

5. The apparatus of claim 1, wherein the cleaning agent comprises steam.

6. The apparatus of claim 1, wherein the cleaning agent comprises a pressurized gas.

7. The apparatus of claim 1, wherein the controller is adapted to direct the first switch to expose the cleaner entry aperture only when the first switch is sealing the liquid entry aperture.

8. The apparatus of claim 1, further comprising a flushing switch of the plurality of modules, the flushing switch coupled with the controller and adapted as directed by the controller to alternately expose and seal a flushing entry aperture, the flushing entry aperture adapted to enable a flushing agent to enter the channel, and wherein the controller is further adapted to control the first switch, the second switch and the flushing switch to prohibit a simultaneous entry of the cleaning agent, the liquid medium and the flushing agent into the channel.

9. The apparatus of claim 8, wherein the channel exit feature is further adapted to enable exit of the flushing agent from the channel.

10. The apparatus of claim 8, wherein the flushing agent comprises water.

11. The apparatus of claim 8, further comprising a channel exit switch, the channel exit switch coupled with the controller and adapted as directed by the controller to alternately enable and disable the channel exit feature from permitting exit of the cleaning agent, the liquid medium and the flushing agent from the channel.

12. The apparatus of claim 1, further comprising:
the cleaning agent comprising a pressurized gas;
a reservoir, the reservoir containing the pressurized gas and coupled with the channel; and
a reservoir switch of the plurality of modules, the reservoir switch coupled with the controller and disposed between the reservoir and the cleaner entry aperture, and the reservoir switch adapted as directed by the controller to alternately enable and egress of the pressurized gas from the reservoir.

13. The apparatus of claim 12, wherein the cleaning agent comprises steam.

14. The apparatus of claim 12, wherein the controller is adapted to direct the cleaner source switch to enable egress of cleaning agent from the source of the pressurized gas only when the second switch is exposing the cleaner entry aperture.

15. An apparatus comprising:
a controller, the controller adapted to selectively enable and disable a plurality of electromechanical means (“plurality of means”);
a channel, the channel comprising an exit port and the channel adapted to provide a transference pathway of a liquid material;
a first means of the plurality of means, the first means adapted to ‘alternately enable and disable transference of the liquid material through the channel and out of the exit port; and
a second means of the plurality of means, the second means adapted to ‘alternately enable and disable introduction of a cleaning agent liquid material into the channel and out of the exit port, wherein the controller is adapted to control the first means and the second means to prohibit a simultaneous entry of the cleaning agent and the liquid medium into the channel; and

16. The apparatus of claim 15, wherein the liquid material comprises alcohol.

17. The apparatus of claim 15, wherein the liquid material comprises beer.

18. The apparatus of claim 15, wherein the cleaning agent comprises steam.

19. The apparatus of claim 15, wherein the cleaning agent comprises a pressurized gas.

20. A method comprising:
a. Flowing a liquid through a channel;
b. Automatically and temporarily disabling introduction of the liquid into the channel, the disabling effected by a preprogrammed device;
c. Passing a cleansing agent through the channel;
d. Halting introduction of the cleansing agent through the channel; and
e. Resuming the flowing of the liquid through a channel.

21. The method of claim 20, wherein the liquid comprises alcohol.

22. The method of claim 20, wherein the liquid comprises beer.

23. The method of claim 20, wherein the cleansing agent comprises steam.

24. The method of claim 20, wherein the cleansing agent comprises a pressurized gas.
